(19) United States
(12) Patent Application Publication
(10) Pub. No.: US 2023/0281932 A1
(43) Pub. Date: Sep. 7, 2023

(54) METHOD AND SYSTEM OF INTERACTION

(71) Applicant: David Franklin Hanson, JR., Richardson, TX (US)

(72) Inventor: David Franklin Hanson, JR., Richardson, TX (US)

(21) Appl. No.: 17/685,085

(22) Filed: Mar. 2, 2022

(51) Int. Cl. G06T 19/00; G06N 7/00; G06N 7/02

(52) U.S. Cl. CPC G06T 19/006; G06N 7/005; G06N 7/023

(57) ABSTRACT

A method of interaction is disclosed. In an embodiment, the method may include configuring a hierarchical action-structure, in response to receiving a predefined objective. Configuring may include determining one or more first-level actions associated with the predefined objective and determining one or more second-level actions associated with each of the one or more first-level actions. The method may further include executing the one or more first-level actions by executing the corresponding one or more second-level actions and detecting a reaction of an interactee in response to the execution of the one or more second-level actions. The method may further include determining a fitness value associated with each of the one or more second-level actions and the one or more first-level actions for fitness with the predefined objective, and reconfiguring the hierarchical action-structure, based on the determined fitness value.

### TECHNICAL FIELD

This disclosure relates generally to performing interaction, and more particularly to method and system of performing interaction by a virtual character with an interactee.

### BACKGROUND

With the advent of immersive technologies, for example, Augmented Reality (AR) and Virtual Reality (VR) technologies, there has been increasing emphasis on developing interaction capabilities in virtual characters implemented by computing devices and robots. Some technologies based on Psi-frameworks like MicroPsi, and OpenPsi define models of human motivation and emotion, with special attention given to the design of human-like actions and goals. These technologies focus on interaction of drives, urges, and needs to create affective states to modulate or motivate behavior. Some of above technologies attempt to model human behavior, however, fail to take in account learning, reasoning, perception, or actions. Further, some technologies use sub-symbolic methods like neural network-based knowledge representation, while some other technologies are based on symbolic methods like hypergraph knowledge representations.

For learning and improvement of the technologies, it may be essential to define goals and actions and continuously evaluate the fitness of these goals and actions directed toward modeling human behavior. However, the above technologies known in the art do not use data to evaluate the fitness of goals, and as result are unable to learn, grow, and change to become more human-like over time. For example, in the sub-symbolic frameworks, there is not enough transparency for human authors and developers to curate positive goals. Further, these technologies do not use Machine Learning (ML) to evaluate the satisfaction or fitness of goals based on perceived or collected data, and also do not define objective functions for human-like goals.

### SUMMARY

In one embodiment, a method of interaction is disclosed. The method may include configuring a hierarchical action-structure, in response to receiving a predefined objective. Configuring the hierarchical action-structure may include determining one or more first-level actions associated with the predefined objective and determining one or more second-level actions associated with each of the one or more first-level actions. The method may further include executing each of the one or more first-level actions by executing each of the corresponding one or more second-level actions and detecting a reaction of an interactee in response to the execution of each of the one or more second-level actions. The method may further include determining a fitness value associated with each of the one or more second-level actions and each of the one or more first-level actions for fitness with the predefined objective. The fitness value may be determined based the detected reaction. The method may further include reconfiguring the hierarchical action-structure, based on the determined fitness value.

In another embodiment, a system for performing interaction is disclosed. The system may include a processor and a memory communicatively coupled to the processor. The memory stores a plurality of processor-executable instructions which upon execution by the processor cause the processor to configure a hierarchical action-structure, in response to receiving a predefined objective. Configuring the hierarchical action-structure may include determining one or more first-level actions associated with the predefined objective and determining one or more second-level actions associated with each of the one or more first-level actions. The plurality of processor-executable instructions, upon execution by the processor, may further cause the processor to execute each of the one or more first-level actions by executing each of the corresponding one or more second-level actions and detect a reaction of an interactee in response to the execution of each of the one or more second-level actions. The plurality of processor-executable instructions, upon execution by the processor, may further cause the processor to determine a fitness value associated with each of the one or more second-level actions and each of the one or more first-level actions for fitness with the predefined objective (the fitness value being determined based the detected reaction), and reconfigure the hierarchical action-structure, based on the determined fitness value.

In yet another embodiment, a non-transitory computer-readable medium storing computer-executable instructions for performing interaction is disclosed. The computer-executable instructions may be configured for configuring a hierarchical action-structure, in response to receiving a predefined objective. Configuring the hierarchical action-structure may include determining one or more first-level actions associated with the predefined objective and determining one or more second-level actions associated with each of the one or more first-level actions. The computer-executable instructions may be further configured for executing each of the one or more first-level actions by executing each of the corresponding one or more second-level actions and detecting a reaction of an interactee in response to the execution of each of the one or more second-level actions. The computer-executable instructions may be further configured for determining a fitness value associated with each of the one or more second-level actions and each of the one or more first-level actions for fitness with the predefined objective (the fitness value being determined based the detected reaction), and reconfiguring the hierarchical action-structure, based on the determined fitness value.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of a system for performing interaction, in accordance with an embodiment.

FIG. 2 is a functional block diagram of an interaction device of the system for performing interaction, in accordance with an embodiment.

FIG. 3 is a block diagram of a hierarchical action-structure, in accordance with an embodiment.

FIG. 4A is a block diagram of an example hierarchical structure in accordance with an embodiment.

FIG. 4B is a block diagram of an example hierarchical structure as an extension to the hierarchical structure of FIG. 4A, in accordance with an embodiment.

FIG. 5 is a graphical representation of satisfaction trends for the one or more first-level actions and the one or more second-level actions over a period of time, in accordance with an embodiment.

FIG. 6 is a flowchart illustrating a method of interaction, in accordance with an embodiment.

FIG. 7 is a block diagram of an exemplary computer system for implementing various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

One or more techniques are disclosed that seek to provide a solution to the above-mentioned challenges faced by the technologies of the prior art, by using sub-symbolic methods of reinforcement learning and adversarial networks across symbolic representations hypergraphs. A hierarchical structure is defined with a metagoal (also, referred to as predefined objective in this disclosure) and multiple goals (also, referred to as first-level actions) and actions (also, referred to as second-level action). Reaction of an interactee in response to the execution of actions is obtained using sensors (i.e. perceived or collected data), and this perceived or collected data is used to measure satisfaction level of the actions and goals. By continuously learning from the previous experiences, the techniques improve over time. The techniques further provide for creation and destruction of goals and actions, thereby preventing fixation on only some of the goals or actions without consideration to undiscovered goals and actions. By providing a fully-defined affective space map and a well curated set of initial goals and actions, the techniques allow the virtual characters or robots to grow toward more human-like behavior over time. The metagoal is intentionally designed to be unsatisfiable. In other words, the metagoal does not settle on a single set of goals or actions but will instead constantly seek out better candidates for the goals or actions, thereby solving the convergence problem of other Artificial Intelligence (AI)-based virtual characters.

Thus, the techniques of the present disclosure are based on reinforcement learning algorithm applied to the evaluation and reevaluation of goals and actions (for the virtual character embodied in a physical robot or in virtual context), based on the perception of interactee or collection of data metrics to motivate behavior and modulate emotional states in a human-like way. Measuring the satisfaction of a goal based on the perception increases the fidelity of human-like behaviors, while measuring the fitness of a goal allows for the techniques to reinforce this trend, thereby growing to have more human-like behaviors over time. In order to achieve the human-like behaviors, the techniques constantly reevaluate the fitness of goals and actions based on three criteria which are later discussed in this disclosure.

Since service robotics and virtual character industries are expected to expand in the coming years, the technologies provided by the present disclosure may allow robots and virtual characters to augment or replace human labor in a generalized way. Further, these techniques may be helpful in providing a human-machine interface that is intuitive and predictable. By showing the goals of the robot or the virtual character in an open and transparent way, the techniques may help ease public ethical concerns and further drive innovation.

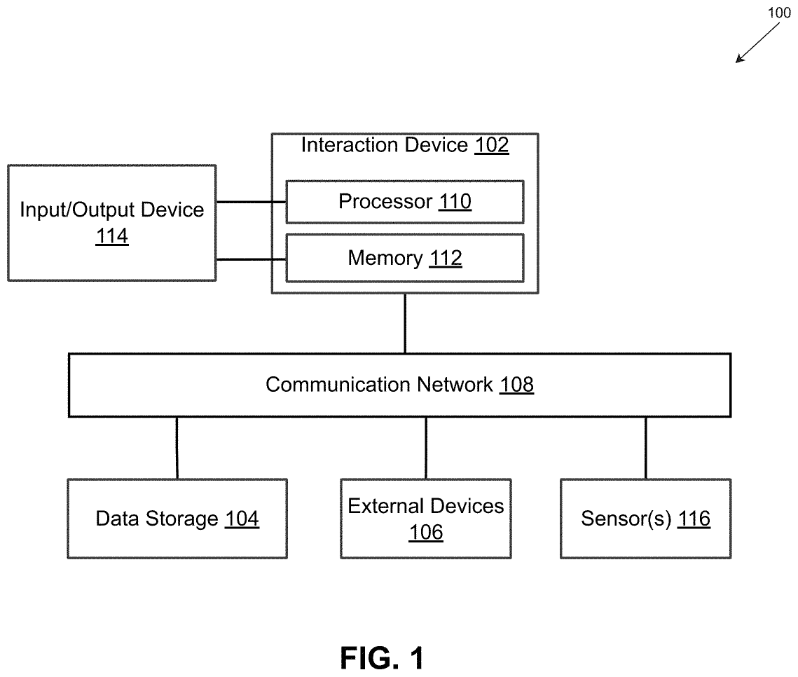

In one embodiment, a block diagram of a system 100 for performing interaction is illustrated in FIG. 1, in accordance with an embodiment. The system 100 may include an interaction device 102. The interaction device 102 may be a computing device having data processing capability. In particular, the interaction device 102 may have capability for performing interaction with a human, a robot, a computing device, or a virtual character. Examples of the interaction device 102 may include, but are not limited to a desktop, a laptop, a notebook, a netbook, a tablet, a smartphone, a mobile phone, an application server, a web server, or the like. The system 100 may further include a data storage 104. For example, the data storage 104 may store various types of data required by the interaction device 102 for performing interaction. The interaction device 102 may be communicatively coupled to the data storage 104 via a communication network 108. The communication network 108 may be a wired or a wireless network and the examples may include, but are not limited to the Internet, Wireless Local Area Network (WLAN), Wi-Fi, Long Term Evolution (LTE), Worldwide Interoperability for Microwave Access (WiMAX), and General Packet Radio Service (GPRS).

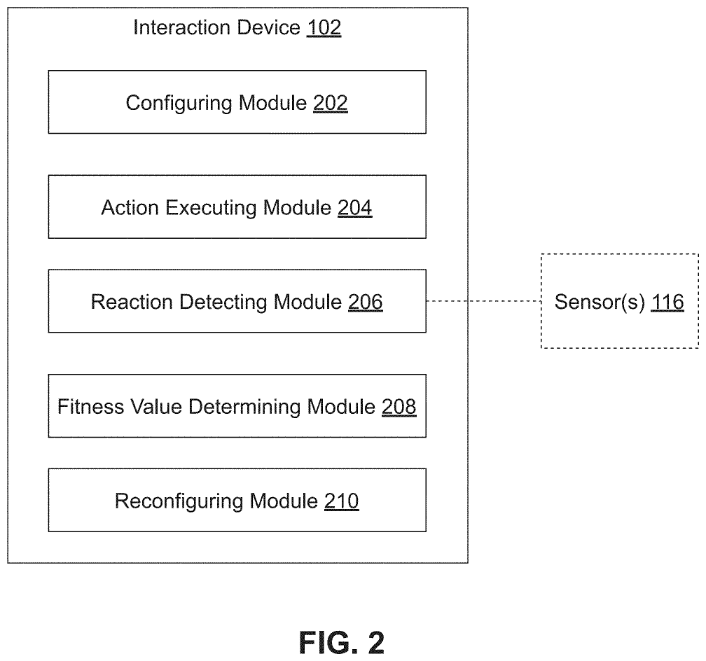

As will be described in greater detail in conjunction with FIG. 2 to FIG. 6, in order to perform interaction, the interaction device 102 may configure a hierarchical action-structure, in response to receiving a predefined objective and determine one or more first-level actions associated with the predefined objective. The interaction device 102 may further determine one or more second-level actions associated with each of the one or more first-level actions and execute each of the one or more first-level actions by executing each of the corresponding one or more second-level actions. The interaction device 102 may further detect a reaction of an interactee in response to the execution of each of the one or more second-level actions and determine a fitness value associated with each of the one or more second-level actions and each of the one or more first-level actions for fitness with the predefined objective, the fitness value being determined based the detected reaction. The interaction device 102 may further reconfigure the hierarchical action-structure, based on the determined fitness value.

In order to perform the above-discussed functionalities, the interaction device 102 may include a processor 110 and a memory 112. The memory 112 may store instructions that, when executed by the processor 110, cause the processor 110 to select perform interaction with an interactee, as discussed in greater detail in FIG. 2 to FIG. 6. The memory 112 may be a non-volatile memory or a volatile memory. Examples of non-volatile memory, may include, but are not limited to a flash memory, a Read Only Memory (ROM), a Programmable ROM (PROM), Erasable PROM (EPROM), and Electrically EPROM (EEPROM) memory. Examples of volatile memory may include, but are not limited to Dynamic Random-Access Memory (DRAM), and Static Random-Access memory (SRAM). The memory 112 may also store various data (e.g. sensor data, comparison data, Machine Learning (ML) data, etc.) that may be captured, processed, and/or required by the system 100.

The interaction device 102 may further include one or more input/output devices 114 through which the interaction device 102 may interact with a user and vice versa. By way of an example, the input/output device 114 may be used to display a reaction, or a fitness value, etc., as will be discussed later. The system 100 may interact with one or more external devices 106 over the communication network 108 for sending or receiving various data. Examples of the one or more external devices 106 may include, but are not limited to a remote server, a digital device, or another computing system.

The system 100 may further include one or more sensors 116. The interaction device 102 may be communicatively coupled to the one or more sensors 116 via the communication network 108. The one or more sensors 116 may be configured to obtain sensor data associated with an interactee, in response to the execution of each of the one or more second-level actions. For example, the sensor data may include at least one of an animation, a movement, a tone of voice, and a facial expression of the interactee. As such, the one or more sensors may include audio sensors (e.g. microphones, image sensors, etc.)

Referring now to FIG. 2, a functional block diagram of the interaction device 102 for performing interaction is illustrated, in accordance with an embodiment of the present disclosure. In some embodiments, the interaction device 102 may include a configuring module 202, an action executing module 204, reaction detecting module 206, a fitness value determining module 208, and a reconfiguring module 210.

The configuring module 202 may configure a hierarchical action-structure, in response to receiving a predefined objective. It should be noted that configuring the hierarchical action-structure may further include determining one or more first-level actions associated with the predefined objective and determining one or more second-level actions associated with each of the one or more first-level actions. The configuring module 202 may be further configured to determine a first sequence associated with the one or more first-level actions associated with the predefined objective. It should be noted that the one or more first-level actions are to be executed in the first sequence. The configuring module 202 may be further configured to determine a second sequence associated with the one or more second-level actions associated with each of the one or more first-level actions. The one or more second-level actions are to be executed in the second sequence. In some embodiments, the configuring module 202 may predict the first sequence and the second sequence based on a probability distribution model and/or a fuzzy logic model. In some embodiments, the configuring module 202 may assign an immunity status to a first-level action of the one or more first-level actions or a second-level action of the one or more second-level actions. The immunity status may make the first-level action and the second-level action immune to the reconfiguring. In other words, when the hierarchical structure is reconfigured, the immunity status may protect the content and integrity of the first-level action or the second-level action and disallow modifications thereof.

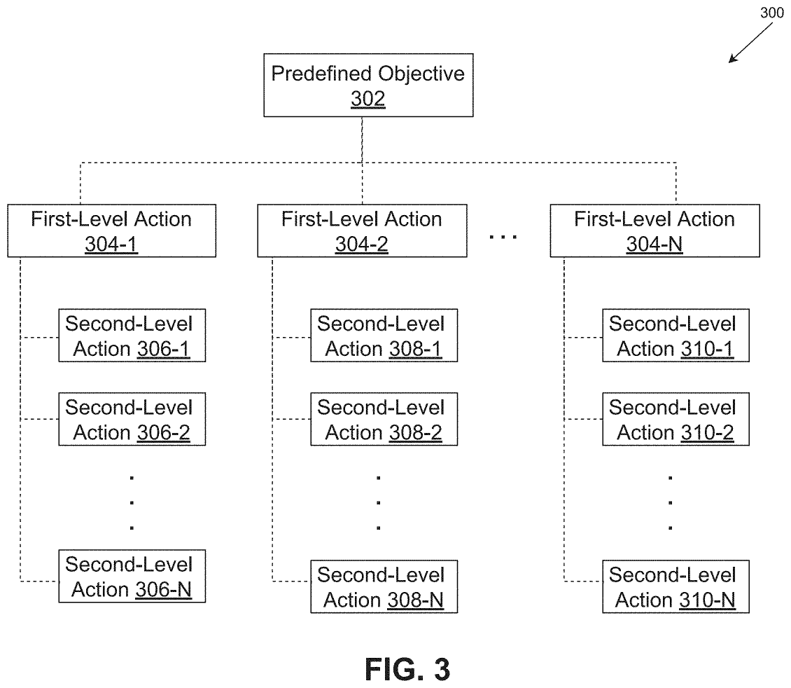

In some embodiments, the configuring module 202 may configure the hierarchical action-structure using a first Machine Learning (ML) model. In other words, the one or more first-level actions associated with the predefined objective and the one or more second-level actions associated with each of the one or more first-level actions may be determined using the first ML model. For example, the first ML model may be based on a generative adversarial network (GAN), a deep neural network, a convolutional neural network (CNN), a variational autoencoder (VAE), a cycle-consistency adversarial network, a probabilistic logic network (PLN), or a reinforcement learning model. The hierarchical action-structure is further explained in detail in conjunction with FIG. 3.

Referring now to FIG. 3, a block diagram of a hierarchical action-structure 300 is illustrated, in accordance with an embodiment of the present disclosure. As shown in FIG. 3, the hierarchical action-structure 300 may include a predefined objective 302. The predefined objective 302 may be received from a user. The hierarchical action-structure 300 may further include one or more first-level actions 304-1, 304-2, . . . 304-N (hereinafter, collectively referred to as one or more first-level actions 304). Each of the one or more first-level actions 304 may be associated with the predefined objective 302. Further, each of the one or more first-level actions 304 may be associated with one or more second-level actions. In particular, the first-level actions 304-1 may be associated with one or more one or more second-level actions 306-1, 306-2, . . . 306-N. similarly, the first-level actions 304-2 may be associated with one or more one or more second-level actions 308-1, 308-2, . . . 308-N, and so on.

Referring back to FIG. 2, the action executing module 204 may be configured to execute each of the one or more first-level actions 304 by executing each of the corresponding one or more second-level actions 306. For example, a first-level actions may be executable by executing the associated second-level actions. During operation, the one or more first-level actions 304 may be executed in the first sequence. For example, as shown in FIG. 3, according to the first sequence, first the first-level action 304-1 may be executed followed by the first-level actions 304-2, and so on. Further, during operation, the one or more second-level actions 306 may be executed in the second sequence. For example, according to the second sequence for the one or more second-level actions 306 associated with the first-level action 304-1, first the second-level action 306-1 may be executed followed by the second-level action 306-2, and so on. Similarly, according to the second sequence for the one or more second-level actions 306 associated with the first-level action 304-2, first the second-level action 308-1 may be executed followed by the second-level action 308-2, and so on.

The reaction detecting module 206 may detect a reaction of an interactee in response to the execution of each of the one or more second-level actions 306. In order to detect the reaction of the interactee, the reaction detecting module 206 may obtain sensor data associated with an interactee using the one or more sensors 116, in response to the execution of each of the one or more second-level actions 306. In some embodiments, the one or more sensors 116 may include a visual sensor (i.e. a camera), an audio sensor, etc. By way of an example, the sensor data may include at least one of an animation, a movement, a tone of voice, and a facial expression of the interactee. To this end, the reaction detecting module 206 may be communicatively coupled to the one or more sensors 116. The reaction detecting module 206 may further detect the reaction of the interactee based on the sensor data, for example, using a ML model like a Generative Adversarial Network (GAN) model.

The fitness value determining module 208 may determine a fitness value associated with each of the one or more second-level actions 306 and each of the one or more first-level actions 304 for fitness with the predefined objective. For example, the fitness value is indicative of the extent to which the second-level action is able to satisfy the associated first-level action and therefore the predefined objective. The fitness value may be determined based on the detected reaction of the interactee in response to the execution of each of the one or more second-level actions 306. In order to determine the fitness value associated with each of the one or more second-level actions 306, the fitness value determining module 208 may compare the detected reaction with a predicted reaction. For example, if a predicted reaction in response to execution of a second-level action ‘telling a joke’ is ‘laughter’, then the fitness value of this second-level action may be determined by comparing the detected reaction with ‘laughter’ (i.e. how close the detected reaction is to laughter, or to what extent ‘laughter’ is induced in the interactee). Further, based on the fitness value determined to be associated with the one or more second-level actions 306, the fitness value associated with each of the one or more first-level actions 304 may be determined.

In some embodiments, the fitness value determining module 208 may determine the fitness value associated with a second-level action of the one or more second-level actions 306 based on one or more criteria. By way of an example, the one or more criteria may include a perceptibility of the second-level action by the interactee, a measurability of the reaction of the interactee in response to the execution of the second-level action, and a relatability of the second-level action with remaining of the one or more second-level actions.

In some embodiments, in order to determine the fitness value associated with each of the one or more second-level actions 306 and each of the one or more first-level actions 304, the fitness value determining module 208 may receive a predicted reaction of the interactee associated with each of the one or more second-level actions 306. Further, the fitness value determining module 208 may determine the fitness value associated with each of the one or more second-level actions 306 and each of the one or more first-level actions 304 based on a comparison of the detected reaction with the predicted reaction.

The reconfiguring module 210 may reconfigure the hierarchical action-structure 300 based on the determined fitness value. In particular, in some embodiments, the reconfiguring module 210 may remove a second-level action of the one or more second-level actions 306, when the fitness value associated with the second-level action is less than the predefined second fitness threshold value. Additionally or alternately, the reconfiguring module 210 may remove a first-level action of the one of the one of more first-level actions 304, when the fitness value associated with the first-level action is less than the predefined first threshold value. Further, in some embodiments, the reconfiguring module 210 may generate at least one new second-level action related to a second-level action of the one or more second-level actions 306, when the fitness value associated with the second-level action of the one or more second-level actions is greater than the predefined second threshold value. Additionally or alternately, the reconfiguring module 210 may generate at least one new first-level action related to a first-level action of the one or more first-level actions 304, when the fitness value associated with the first-level action of the one or more first-level actions 304 is greater than the predefined first threshold value. Further, in some embodiments, the reconfiguring module 210 may rearrange the one or more first-level actions 304 associated with the first sequence, based on the comparison of the fitness value associated with each of the one or more first-level actions 304 with the predefined first threshold value. Additionally or alternately, the reconfiguring module 210 may rearrange the one or more second-level actions 306 associated with the second sequence, based on the comparison of the fitness value associated with each of the one or more second-level actions with the predefined second threshold value.

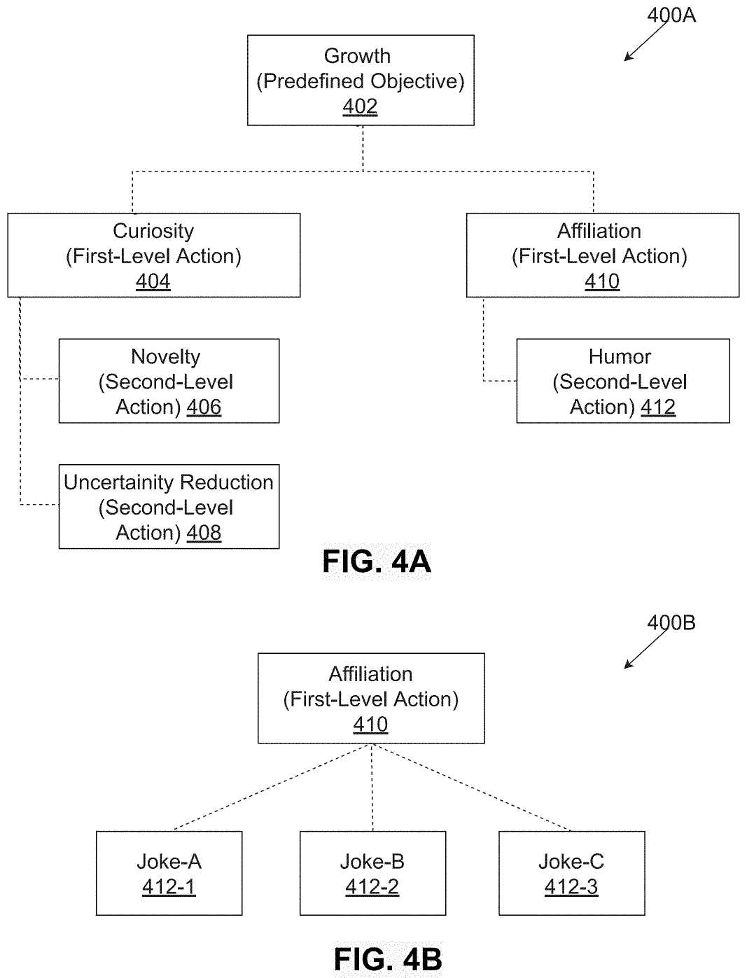

Referring now to FIG. 4A, a block diagram of an example hierarchical structure 400A (corresponding to the hierarchical structure 300) is illustrated in accordance with an embodiment. As shown in FIG. 4A, the hierarchical structure 400A includes a predefined objective Growth 402. Further, the hierarchical structure 400A includes a first-level action Curiosity 404 and a first-level action Affiliation 410 associated with the predefined objective Growth 402. The hierarchical structure 400A further includes a second-level action Novelty 406 and a second-level action Uncertainty Reduction 408 associated with the first-level action Curiosity 404, and a second-level action Humor 412 associated with the first-level action Affiliation 410.

The first-level action Curiosity 404 is to be executed by executing the associated second-level action Novelty 406 and the second-level action Uncertainty Reduction 408. Similarly, the first-level action Affiliation 410 is to be executed by executing the associated second-level action Humor 412. A reaction of an interactee may be detected in response to the execution of each of the second-level actions, using the one or more sensors 116. Further, a fitness value associated with each of the first-level actions Curiosity 404 and Affiliation 410, and each of the second-level actions Novelty 406, Uncertainty Reduction 408, and second-level action Humor 412 may be determined. As mentioned above, the fitness value is indicative of the extent to which the second-level action is able to satisfy the associated first-level action and therefore the predefined objective. The hierarchical action-structure 400A may be reconfigured based on the determined fitness value. To this end, a ML model, for example, a GAN model may be used to automatically train a neural network version of the first-level actions and second-level actions.

Referring now to FIG. 4B, a block diagram of an example hierarchical structure 400B as an extension to the hierarchical structure 400A is illustrated, in accordance with an embodiment. The hierarchical structure 400B includes the first-level action Affiliation 410. The hierarchical structure 400B further includes a second-level action Joke-A 412-1, a second-level action Joke-B 412-2, and a second-level action Joke-C 412-3 (corresponding to the second-level action Humor 412) associated with the first-level action Affiliation 410. During operation, the first-level action Affiliation 410 may be selected based on current urge levels and importance. As will be understood, affiliation may be related with making friends. As such, the first-level action Affiliation 410 may be satisfied by executing one or more second-level actions, e.g., Joke-A, Joke-B, and Joke-C. In order to satisfy the first-level action Affiliation 410, the virtual character may first attempt to execute the second-level action Joke-A 412-1. In other words, the virtual character may first attempt to tell a Joke-A to an interactee (for example, the interactee may be a human, another virtual character, a robot, etc.). Once the second-level action Joke-A 412-1 is executed, a reaction of the interactee in response to the execution of the second-level action Joke-A 412-1 is detected. For example, an animation, an expression, or a voice action of the interactee in response to telling of the Joke-A may be detected. In order to detect the reaction of the interactee, sensor data associated with the interactee may be obtained using the one or more sensors 116, and the reaction of the interactee may be determined based on the sensor data. The sensor data may, thus, include an animation, a movement, a tone of voice, and a facial expression of the interactee.

A target reaction in this case may be laughter. Therefore, based on the sensor data (i.e, the animation, the movement, the tone of voice, or the facial expression of the interactee), it may be determined whether the reaction of the interactee amounts to laughter or not. In particular, the fitness value associated with the second-level action Joke-A 412-1 may correspond to the extent to which the second-level action Joke-A 412-1 was able to induce the target reaction i.e. laughter. As such, for future scenarios, the fitness value may be indicative of future probability of to what extent the second-level action will be able to meet the satisfaction criteria, based on the future context and past performance.

In a scenario when the reaction of laughter is not detected, a low fitness value is determined to be associated with the second-level action Joke-A 412-1, and as such, the second-level action Joke-A 412-1 is considered as unsuccessful. Thereafter, the second-level action Joke-B 412-2 may be attempted, i.e. the virtual character may attempt to tell a Joke B. Thereafter, once the second-level action Joke-B 412-2 is executed, a reaction of the interactee in response to its execution is detected, and fitness value associated with the second-level action Joke-B 412-2 is determined. In a scenario when a low fitness value is determined to be associated with the second-level action Joke-B 412-2 (i.e. the reaction of laughter is not detected,), the second-level action Joke-B 412-2 is considered as unsuccessful. Thereafter, the second-level action Try Joke-C 412-3 may be attempted, i.e. the virtual character may attempt to tell a Joke C, and similarly, a reaction of the interactee in response to its execution is detected and a fitness value associated with the second-level action Try Joke-C 412-3 is determined.

In a scenario when all the three second-level actions, i.e. the Joke-A, the Joke-B, and the Joke-C are unsuccessful, telling jokes may be deemed as inappropriate (since further failures may hurt the virtual character's chances of satisfying other second-level actions and first-level actions). Further, when the three second-level actions, i.e. the Joke-A, the Joke-B, and the Joke-C are unsuccessful, the first-level action Affiliation 410 is unsatisfied. The interaction device 102 then can learn from the above and improve upon with more data, for future scenarios.

The reaction of the interactee (interacting with the virtual character) in response to the execution of the first-level action Affiliation 410 may be obtained. Further, a sentiment analysis may be performed, by measuring various perceptible parameters of the interactee, for example, by gauging tone of voice, facial expressions, and other social cues. A positive sentiment of the interactee may return a positive goal satisfaction. As will be understood, the first-level action Affiliation 410 may rely on several second-level actions like Joke-A, Joke-B, Joke-C, etc. to evaluate each perception (reaction) of the interactee and its contribution to the total satisfaction.

The interaction device 102 may experiment with different first-level actions and second-level actions to determine ones that have the greatest contribution to satisfaction of the predefined objective. The perceptions (reactions) of the interactee may be tracked and recorded whether they are known to contribute to the satisfaction of any current first-level actions and second-level actions or not. Further, some second-level actions may be executed that don't directly satisfy any first-level actions.

In some cases, it may be determined that the current satisfaction of the first level action Affiliation 410 is higher than expected, based on a comparison of the detected reaction with the predicted reaction. As will be understood, this would occur whenever the sentiment analysis of the first-action action Affiliation 410 returns a high positive result where a negative or neutral result was expected for a given set of actions. The interaction device 102 may further identify a correlation between unidentified but perceived audio signals and the increased satisfaction of the first-action action Affiliation 410. The interaction device 102 may query a database (e.g. “Atomspace”—an implementation of knowledge hypergraph) to identify audio signals. To this end, a neural network may be already trained to identify laughter from audio signals.

Having identified that laughter correlates with increased satisfaction of the first-action action Affiliation 410, the interaction device 102 may then look for surprisingly frequent second-level actions successfully resulting in laughter. As will be understood, this works like an event boundary detection, where an event triggered by an action is in close temporal proximity to the perceived reaction. For example, in the above example scenario, a correlation between laughter and telling Joke(s) may be discovered.

A Probabilistic Logic Network (PLN) may be used to evaluate the likelihood that a given action (telling a Joke) will result in an expected perception (i.e. laughter) which will in turn result in an expected satisfaction (for the first-action action Affiliation 410). The fitness value associated with inferences may be often low. The interaction device 102 may then experiment with a few first-level and second-level actions as well as behaviors to find the highest fitness value. As such, the above process might iterate several times. Once the transitive inference of feedback-based loop (i.e. action>perception>satisfaction) has been found with a high confidence, a process of generating a new first-level action or a new second-level action may be started. This is to encourage the planning of the actions (i.e. first-level actions or second-level actions) that led to the higher degree of overall satisfaction. Since an objective of the interaction device is to maximize the total satisfaction of all the current first-level actions, it actively seeks out candidate second-level actions that improve the current rate of total satisfaction. In this case, the candidate doesn't contribute to the goal satisfaction of multiple first-level actions, but just to the satisfaction of one first-level action, thereby making it a candidate second-level action of the first-level action Affiliation 410. As such, the candidate second-level action may include an objective/fitness function that takes as input the identified perception (laughter) and returns as output the fitness value with which the perception satisfies the first-level action Affiliation 410. A second-level action may be identified (telling a joke) that yields this perceived reaction with high probability. It then follows that executing this second-level action will likely satisfy the first-level action Affiliation 410.

In the subsequent step, the second-level action may be named or labeled (for example, in the database—“Atomspace”), but this time looking for concept nodes with the strongest links to both the associated actions and reactions. The second-level action Humor 412 (i.e. second-levels actions Joke-A, Joke-B, Joke-C) would likely have a strong association with the perception of laughter. As such, the candidate second-levels actions Joke-A, Joke-B, Joke-C may be named as Comedy. A candidate action may be promoted into the Comedy category, thereby allowing to begin incorporating the implied actions into larger behaviors.

The above example shows how a second-level action may be generated when there is already a labeled objective/fitness function (in the form of a neural network) to identify strongly correlated perception data as part of a minimizing/maximizing strategy. It also benefits from having a pre-scripted labeled action (telling a joke) executed as part of experiments. Based on the above, new second-level action or even new first-level actions may be generated.

The interaction device 102 (e.g. the reconfiguring module 210 of the interaction device 102) may evaluate the difference between the expected and measured satisfaction of each second-level action, and as a result may generate new first-level actions and second-level actions and/or remove existing first-level actions and second-level actions. In deciding whether to generate or remove a first-level action or a second-level action, the interaction device 102 may consider three criteria— (i) whether the first-level action/second-level action is intuitive for humans to understand? (ii) does the first-level action/second-level action have clearly measurable metrics for satisfaction, and (iii) does the process of satisfaction of the first-level action/second-level action strongly correlate with the process for satisfaction of other first-level actions and second-level actions? The first criteria may be based on applying mathematical models of simplicity, beauty, interestingness, and surprisingness to the symbolic nodes in the database (i.e. “Atomspace”) to find most intuitive concepts for humans to understand. For example, satisfaction of telling a joke can be measured by the perception of laughter which strongly correlates with the satisfaction of other first-level actions, such as Affiliation 410. Sometimes the relationship between first-level actions and second-level actions may not be clear.

It should be noted that the predefined objective Growth 402 may be unsatisfiable, since its objective/fitness function maximizes the actual satisfaction of all the first-level actions. Moreover, there is enough perception data to consistently find a better fit between measured data and the actual satisfaction than there is between the expected and actual satisfaction. As long as an inference can be made between actions, perceptions, and satisfactions, this will result in a continuously reconfiguring of the hierarchical action 400A.

The process of generating new first-level actions and second-level actions, when one isn't already known, may be performed using a ML model like GAN. Further, when there is no trained neural network to detect the reaction (e.g. laughter) associated with the interactee, the neural network may be first trained, using training dataset that may include, for example, audio samples most correlated with the incidents of increased satisfaction. However, if there is already a labelled dataset present in a database (e.g. “Atomspace”) for the reaction, the same may be used as validation that the audio samples are indeed laughter. Otherwise, the interaction device 102 may need to experiment with different actions to elicit new perceptions to validate the training of the neural network. Thereafter, learning or reasoning may be applied to label the perception accurately (including manual learning such as asking, “What was that sound?”). After labelling, uncertain inference may be used via PLN to find the actions most responsible for those perceived reactions.

As will be understood by those skilled in the art, a generator may be a neural network that proposes candidates for laugh identification, while a discriminator may be a neural network that compares the output of that generator to the reference dataset. When the discriminator is unable to identify the difference between the reference data and the generated data, it may be assumed that the identified audio samples relate to the expected reaction (laughter). As will be further understood, GANs belong to the same family as variational autoencoders (VAEs) and cycle-consistency adversarial networks (SCANs). The GAN may use action, perception, and satisfaction data as signals to train neural networks where appropriate. Symbolic learning and training may rely on a number of specialized components such as a Personal Learning Network (PLN) and MOSES.

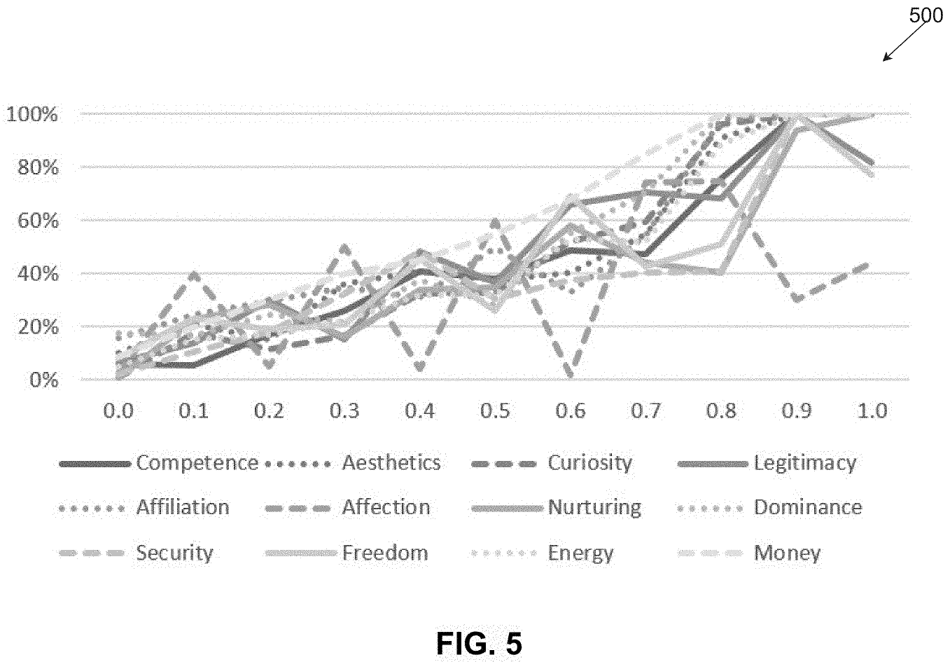

Referring now to FIG. 5, a graphical representation of satisfaction trends 500 for the one or more first-level actions and the one or more second-level actions (corresponding to FIGS. 4A-4B) over a period of time is illustrated, in accordance with an embodiment. As can be seen in FIG. 5, the interaction device 102 may measure correlation of the first-level actions and the second-level actions. In some cases, the interaction device 102 may find that Affection 410 is not strongly correlated with the satisfaction of other first-level actions, and therefore may be detrimental to the satisfaction of the predefined objective 402 (Growth). As a result, it may choose to either demote the first level-goal Affection 410 amongst the other first level-goals (i.e. rearrange in the predefined sequence associated with the first level-goals), or demote it in the hierarchical order to a level of second-level action. Alternately, it may completely remove the first level-goal Affection 410 from the list of motivating behavior altogether, i.e. remove from the hierarchal structure 400A, in which case it would be tracked as a metric.

In another example, Money may be treated as measurement/metric, or a first level-goal or a second-level action candidate. Accordingly, the interaction device 102 may find that earning and spending Money strongly correlates with its other first level-goals or second-level actions. In that case, the interaction device 102 may promote Money to a top-level goal, motivating new behaviors to earn or spend more money. In this way, the unknown relationships between different goals may be discovered and exploited to maximize the satisfaction of all goals. For example, as shown in FIG. 5, measures of money are shown to be correlated with other top-level goals, so the acquisition of money is generated as a top-level goal, not a subgoal.

It should be noted that the above hierarchical structure (e.g. hierarchical structure 300) are merely exemplary, and as such the hierarchical structure or the methods described in the present disclosure may not be limited to the specific scenarios described above but may extend to other human behavior models like ‘beliefs’ and ‘urges’. For, example, a human behavior model may be based on an urge of ‘drive to live’. As such, the emotions associated with such urge may include ‘fear’ (i.e. overcoming fears), ‘happiness’ (i.e. seeking happiness), etc. Accordingly, an exemplary hierarchical structure may include a predefined objective ‘drive to live’. Further, this hierarchical structure may further include an emotion-based first-level actions, e.g. ‘fear’ and ‘happiness’ associated with the predefined objective ‘drive to live’. Furthermore, the hierarchical structure may include a behavior-based second-level action ‘fear of spiders’ associated with the first-level action ‘fear’.

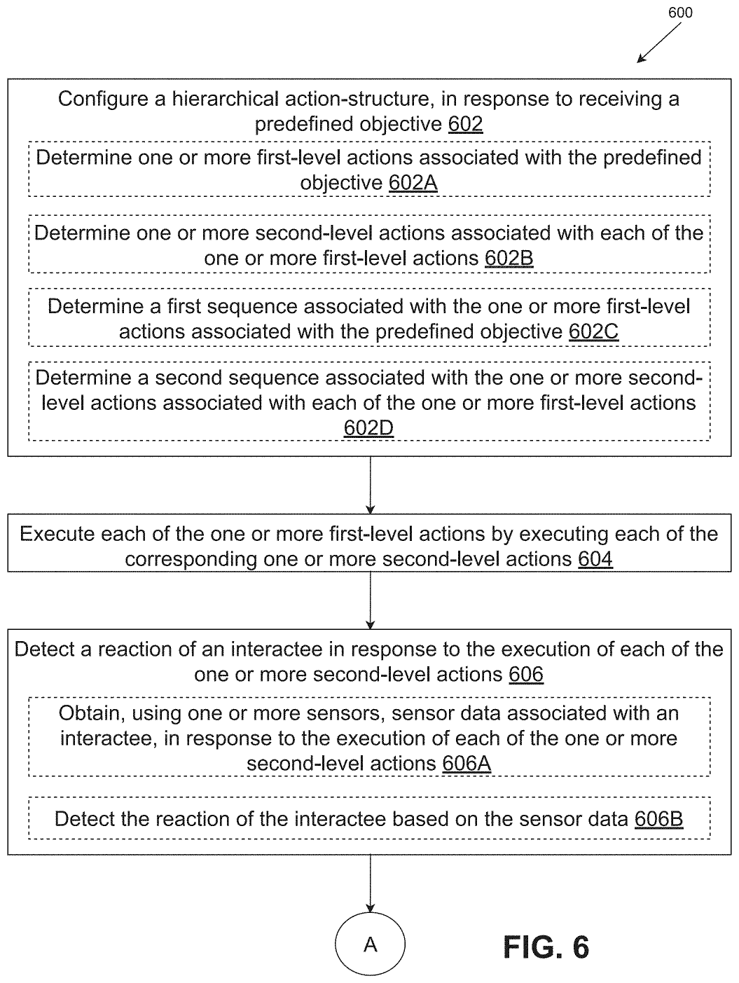

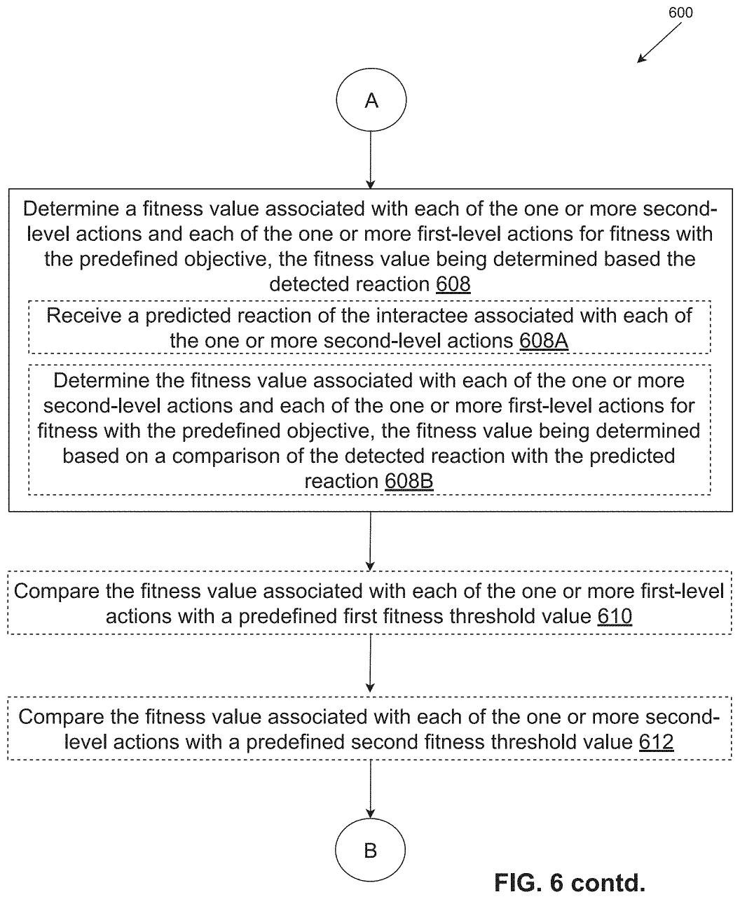

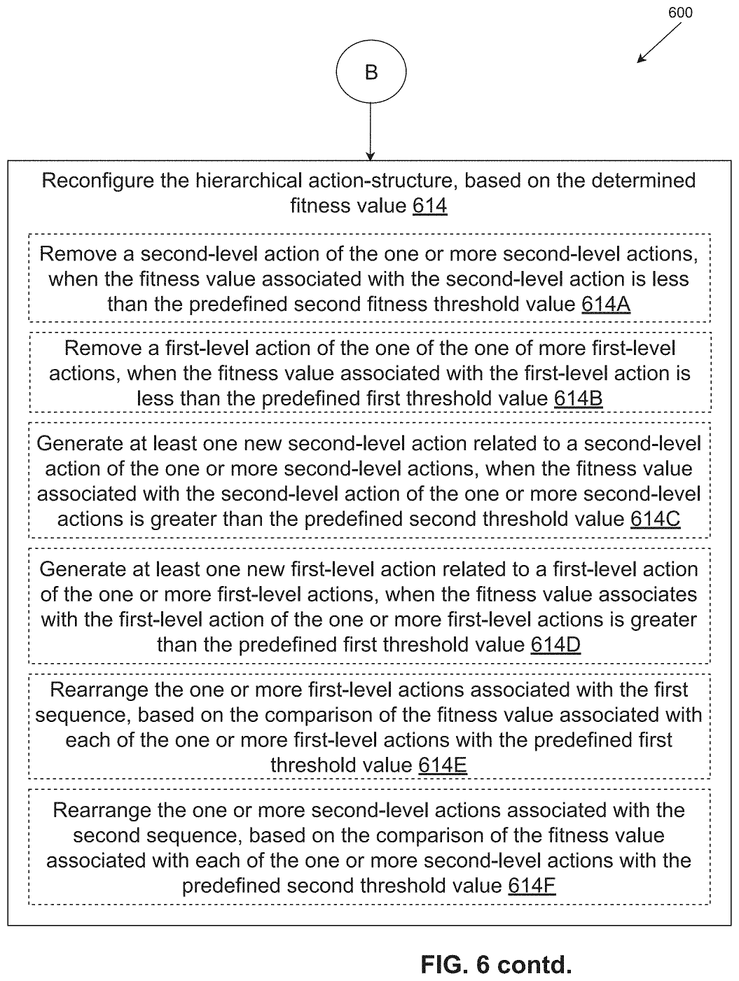

Referring now to FIG. 6, a flowchart of a method 600 of interaction is illustrated, in accordance with an embodiment. The method may include various steps performed by the interaction device 102 in order to perform interaction with an interactee. The interactee may be one of a human, a robot, a computing device, and a virtual character.

At step 602, the hierarchical action-structure may be configured, in response to receiving a predefined objective. In some embodiments, the hierarchical action-structure may be configured using a first Machine Learning (ML) model. For example, the first ML model may be based on one of: a generative adversarial network (GAN), a deep neural network, a convolutional neural network (CNN), a variational autoencoder (VAE), a cycle-consistency adversarial network, a probabilistic logic network (PLN), and a reinforcement learning model.

In some embodiments, configuring the hierarchical action-structure may include steps 602A-602D. For example, at step 602A, one or more first-level actions associated with the predefined objective may be determined. At step 602B one or more second-level actions associated with each of the one or more first-level actions may be determined. The one or more first-level actions associated with the predefined objective and the one or more second-level actions associated with each of the one or more first-level actions are determined using the first ML model. Further, at step 602C, a first sequence associated with the one or more first-level actions associated with the predefined objective may be determined. It should be note that the one or more first-level actions are to be executed in the first sequence. Furthermore, at step 602D, a second sequence associated with the one or more second-level actions associated with each of the one or more first-level actions. The one or more second-level actions are to be executed in the second sequence. In some embodiments, each of the first sequence and the second sequence may be predicted based on at least one of: a probability distribution model and a fuzzy logic model.

In some embodiments, an immunity status may be assigned to a first-level action of the one or more first-level actions or a second-level action of the one or more second-level actions. The immunity status may make the first-level action and the second-level action immune to the reconfiguring.

At step 604, each of the one or more first-level actions may be executed. In some embodiments, each of the one or more first-level actions may be executed by executing each of the corresponding one or more second-level actions. At step 606, a reaction of an interactee in response to the execution of each of the one or more second-level actions may be detected. In order to detect the reaction of the interactee, at step 602A, sensor data associated with an interactee may be obtained, in response to the execution of each of the one or more second-level actions. The sensor data may be obtained using the one or more sensors 116. For example, the sensor data comprises at least one of an animation, a movement, a tone of voice, and a facial expression of the interactee. Further, at step 606B, the reaction of the interactee may be detected based on the sensor data.

At step 608, a fitness value associated with each of the one or more second-level actions and each of the one or more first-level actions for fitness with the predefined objective may be determined. The fitness value being determined based the detected reaction. The fitness value associated with a second-level action (of the one or more second-level actions) may be determined based on one or more criteria. For example, the one or more criteria may include a perceptibility of the second-level action by the interactee, a measurability of the reaction of the interactee in response to the execution of the second-level action, and a relatability of the second-level action with remaining of the one or more second-level actions. In order to determine the fitness value, additionally, at step 608A a predicted reaction of the interactee associated with each of the one or more second-level actions may be received. Further, at step 608B, the fitness value associated with each of the one or more second-level actions and each of the one or more first-level actions may be determined for fitness with the predefined objective. The fitness value may be determined based on a comparison of the detected reaction with the predicted reaction.

In some additional embodiments, at step 610, the fitness value associated with each of the one or more first-level actions may be compared with a predefined first fitness threshold value. Similarly, at step 612, the fitness value associated with each of the one or more second-level actions may be compared with a predefined second fitness threshold value.

At step 614, the hierarchical action-structure may be reconfigured, based on the determined fitness value. In some embodiments, in order to reconfigure the hierarchical action-structure, step 614A-614F may be performed. For example, at step 614A, a second-level action of the one or more second-level actions may be removed from the hierarchical action-structure, when the fitness value associated with the second-level action is less than the predefined second fitness threshold value. At step 614B, a first-level action of the one of the one of more first-level actions may be removed from the hierarchical action-structure, when the fitness value associated with the first-level action is less than the predefined first threshold value. Further, at step 614C, at least one new second-level action related to a second-level action of the one or more second-level actions may be generated and added to the hierarchical action-structure, when the fitness value associated with the second-level action of the one or more second-level actions is greater than the predefined second threshold value. Similarly, at step 614D, at least one new first-level action related to a first-level action of the one or more first-level actions may be generated and added to the hierarchical action-structure, when the fitness value associated with the first-level action of the one or more first-level actions is greater than the predefined first threshold value.

At step 614E, the one or more first-level actions associated with the first sequence may be rearranged, based on the comparison of the fitness value associated with each of the one or more first-level actions with the predefined first threshold value. In other words, the first sequence may be determined once again. At step 614F, the one or more second-level actions associated with the second sequence may be rearranged, based on the comparison of the fitness value associated with each of the one or more second-level actions with the predefined second threshold value. In other words, the second sequence may be determined once again.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

The disclosed methods and systems may be implemented on a conventional or a general-purpose computer system, such as a personal computer (PC) or server computer. It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

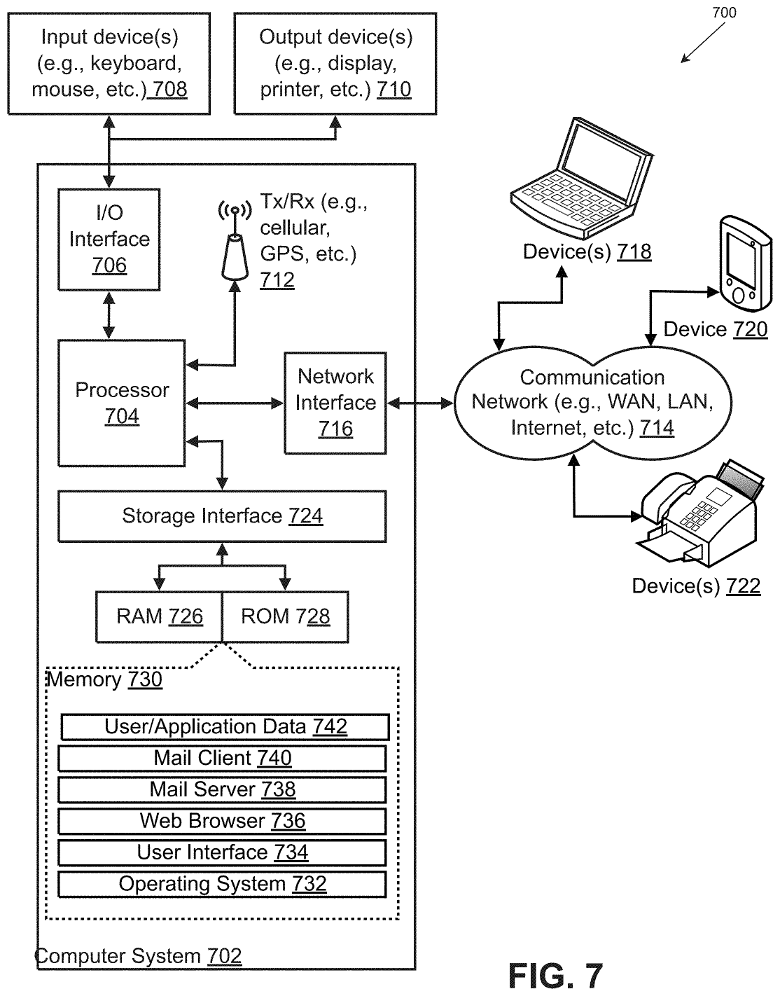

The disclosed methods and systems may be implemented on a conventional or a general-purpose computer system, such as a personal computer (PC) or server computer. Referring now to FIG. 7, a block diagram of an exemplary computer system 702 for implementing various embodiments is illustrated. Computer system 702 may include a central processing unit (“CPU” or “processor”) 704. Processor 704 may include at least one data processor for executing program components for executing user-generated or system-generated requests. A user may include a person, a person using a device such as those included in this disclosure, or such a device itself. Processor 704 may include specialized processing units such as integrated system (bus) controllers, memory management control units, floating point units, graphics processing units, digital signal processing units, etc. Processor 704 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 704 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 704 may be disposed in communication with one or more input/output (I/O) devices via an I/O interface 706. I/O interface 706 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (for example, code-division multiple access (CDMA), high-speed packet access (HSPA+), global system for mobile communications (GSM), long-term evolution (LTE), WiMax, or the like), etc.

Using I/O interface 706, computer system 702 may communicate with one or more I/O devices. For example, an input device 708 may be an antenna, keyboard, mouse, joystick, (infrared) remote control, camera, card reader, fax machine, dongle, biometric reader, microphone, touch screen, touchpad, trackball, sensor (for example, accelerometer, light sensor, GPS, gyroscope, proximity sensor, or the like), stylus, scanner, storage device, transceiver, video device/source, visors, etc. An output device 710 may be a printer, fax machine, video display (for example, cathode ray tube (CRT), liquid crystal display (LCD), light-emitting diode (LED), plasma, or the like), audio speaker, etc. In some embodiments, a transceiver 712 may be disposed in connection with processor 704. Transceiver 712 may facilitate various types of wireless transmission or reception. For example, transceiver 712 may include an antenna operatively connected to a transceiver chip (for example, TEXAS® INSTRUMENTS WILINK WL1286® transceiver, BROADCOM® BCM4550IUB8® transceiver, INFINEON TECHNOLOGIES® X-GOLD 618-PMB9800® transceiver, or the like), providing IEEE 802.6a/b/g/n, Bluetooth, FM, global positioning system (GPS), 2G/3G HSDPA/HSUPA communications, etc.

In some embodiments, processor 704 may be disposed in communication with a communication network 714 via a network interface 716. Network interface 716 may communicate with communication network 714. Network interface 716 may employ connection protocols including, without limitation, direct connect, Ethernet (for example, twisted pair 50/500/5000 Base T), transmission control protocol/internet protocol (TCP/IP), token ring, IEEE 802.11a/b/g/n/x, etc. Communication network 714 may include, without limitation, a direct interconnection, local area network (LAN), wide area network (WAN), wireless network (for example, using Wireless Application Protocol), the Internet, etc. Using network interface 716 and communication network 714, computer system 702 may communicate with devices 718, 720, and 722. These devices 718, 720, and 722 may include, without limitation, personal computer(s), server(s), fax machines, printers, scanners, various mobile devices such as cellular telephones, smartphones (for example, APPLE® IPHONE® smartphone, BLACKBERRY® smartphone, ANDROID® based phones, etc.), tablet computers, eBook readers (AMAZON® KINDLE® ereader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, computer system 702 may itself embody one or more of these devices 718, 720, and 722.

In some embodiments, processor 704 may be disposed in communication with one or more memory devices 730 (for example, RAM 726, ROM 728, etc.) via a storage interface 724. Storage interface 724 may connect to memory 730 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 730 may store a collection of program or data repository components, including, without limitation, an operating system 732, user interface application 734, web browser 736, mail server 738, mail client 740, user/application data 742 (for example, any data variables or data records discussed in this disclosure), etc. Operating system 732 may facilitate resource management and operation of computer system 702. Examples of operating systems 732 include, without limitation, APPLE® MACINTOSH® OS X platform, UNIX platform, Unix-like system distributions (for example, Berkeley Software Distribution (BSD), FreeBSD, NetBSD, OpenBSD, etc.), LINUX distributions (for example, RED HAT®, UBUNTU®, KUBUNTU®, etc.), IBM® OS/2 platform, MICROSOFT® WINDOWS® platform (XP, Vista/7/8, etc.), APPLE® IOS® platform, GOOGLE® ANDROID® platform, BLACKBERRY® OS platform, or the like. User interface 734 may facilitate display, execution, interaction, manipulation, or operation of program components through textual or graphical facilities. For example, user interfaces 734 may provide computer interaction interface elements on a display system operatively connected to computer system 702, such as cursors, icons, check boxes, menus, scrollers, windows, widgets, etc. Graphical user interfaces (GUIs) may be employed, including, without limitation, APPLE® Macintosh® operating systems' AQUA® platform, IBM® OS/2® platform, MICROSOFT® WINDOWS® platform (for example, AERO® platform, METRO® platform, etc.), UNIX X-WINDOWS, web interface libraries (for example, ACTIVEX® platform, JAVA® programming language, JAVASCRIPT® programming language, AJAX® programming language, HTML, ADOBE® FLASH® platform, etc.), or the like.

In some embodiments, computer system 702 may implement a web browser 736 stored program component. Web browser 736 may be a hypertext viewing application, such as MICROSOFT® INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVA® programming language, application programming interfaces (APis), etc. In some embodiments, computer system 702 may implement a mail server 738 stored program component. Mail server 738 may be an Internet mail server such as MICROSOFT® EXCHANGE® mail server, or the like. Mail server 738 may utilize facilities such as ASP, ActiveX, ANSI C++/C #, MICROSOFT .NET® programming language, CGI scripts, JAVA® programming language, JAVASCRIPT® programming language, PERL® programming language, PHP® programming language, PYTHON® programming language, WebObjects, etc. Mail server 738 may utilize communication protocols such as internet message access protocol (IMAP), messaging application programming interface (MAPI), Microsoft Exchange, post office protocol (POP), simple mail transfer protocol (SMTP), or the like. In some embodiments, computer system 702 may implement a mail client 740 stored program component. Mail client 740 may be a mail viewing application, such as APPLE MAIL® mail client, MICROSOFT ENTOURAGE® mail client, MICROSOFT OUTLOOK® mail client, MOZILLA THUNDERBIRD® mail client, etc.

In some embodiments, computer system 702 may store user/application data 742, such as the data, variables, records, etc. as described in this disclosure. Such data repositories may be implemented as fault-tolerant, relational, scalable, secure data repositories such as ORACLE® data repository OR SYBASE® data repository. Alternatively, such data repositories may be implemented using standardized data structures, such as an array, hash, linked list, struct, structured text file (for example, XML), table, or as object-oriented data repositories (for example, using OBJECTSTORE® object data repository, POET® object data repository, ZOPE® object data repository, etc.). Such data repositories may be consolidated or distributed, sometimes among the various computer systems discussed above in this disclosure. It is to be understood that the structure and operation of the any computer or data repository component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of interaction comprising:
configuring, by an interaction device, a hierarchical action-structure, in response to receiving a predefined objective, wherein configuring the hierarchical action-structure comprises:
determining one or more first-level actions associated with the predefined objective; and
determining one or more second-level actions associated with each of the one or more first-level actions;
executing, by the interaction device, each of the one or more first-level actions by executing each of the corresponding one or more second-level actions;
detecting, by the interaction device, a reaction of an interactee in response to the execution of each of the one or more second-level actions;
determining, by the interaction device, a fitness value associated with each of the one or more second-level actions and each of the one or more first-level actions for fitness with the predefined objective, the fitness value being determined based the detected reaction; and
reconfiguring, by the interaction device, the hierarchical action-structure, based on the determined fitness value.

2. The method of claim 1, further comprising:
comparing the fitness value associated with each of the one or more first-level actions with a predefined first fitness threshold value; and
comparing the fitness value associated with each of the one or more second-level actions with a predefined second fitness threshold value.

3. The method of claim 2, wherein the reconfiguring comprises:
removing a second-level action of the one or more second-level actions, when the fitness value associated with the second-level action is less than the predefined second fitness threshold value; and
removing a first-level action of the one of the one of more first-level actions, when the fitness value associated with the first-level action is less than the predefined first threshold value.

4. The method of claim 2, wherein the reconfiguring further comprises at least one of:
generating at least one new second-level action related to a second-level action of the one or more second-level actions, when the fitness value associated with the second-level action of the one or more second-level actions is greater than the predefined second threshold value; and
generating at least one new first-level action related to a first-level action of the one or more first-level actions, when the fitness value associated with the first-level action of the one or more first-level actions is greater than the predefined first threshold value.

5. The method of claim 2, wherein the configuring comprises:
determining a first sequence associated with the one or more first-level actions associated with the predefined objective, wherein the one or more first-level actions are to be executed in the first sequence; and
determining a second sequence associated with the one or more second-level actions associated with each of the one or more first-level actions, wherein the one or more second-level actions are to be executed in the second sequence.

6. The method of claim 5, wherein the reconfiguring further comprises at least one of:
rearranging the one or more first-level actions associated with the first sequence, based on the comparison of the fitness value associated with each of the one or more first-level actions with the predefined first threshold value; and
rearranging the one or more second-level actions associated with the second sequence, based on the comparison of the fitness value associated with each of the one or more second-level actions with the predefined second threshold value.

7. The method of claim 5, wherein each of the first sequence and the second sequence is predicted based on at least one of: a probability distribution model and a fuzzy logic model.

8. The method of claim 1, wherein the fitness value associated with a second-level action of the one or more second-level actions is determined based on one or more criteria, wherein the one or more criteria comprises:
a perceptibility of the second-level action by the interactee;
a measurability of the reaction of the interactee in response to the execution of the second-level action; and
a relatability of the second-level action with remaining of the one or more second-level actions.

9. The method of claim 1, further comprising:
receiving a predicted reaction of the interactee associated with each of the one or more second-level actions; and
determining the fitness value associated with each of the one or more second-level actions and each of the one or more first-level actions for fitness with the predefined objective, the fitness value being determined based on a comparison of the detected reaction with the predicted reaction.

10. The method of claim 1, wherein the hierarchical action-structure is configured using a first Machine Learning (ML) model, and wherein the one or more first-level actions associated with the predefined objective and the one or more second-level actions associated with each of the one or more first-level actions are determined using the first ML model.

12. The method of claim 10, wherein the first ML model is based on one of: a generative adversarial network (GAN), a deep neural network, a convolutional neural network (CNN), a variational autoencoder (VAE), a cycle-consistency adversarial network, a probabilistic logic network (PLN), and a reinforcement learning model.

13. The method of claim 1, wherein configuring the hierarchical action-structure further comprises:
assigning an immunity status to a first-level action of the one or more first-level actions or a second-level action of the one or more second-level actions, wherein the immunity status is to make the first-level action and the second-level action immune to the reconfiguring.

14. The method of claim 1, wherein detecting the reaction of the interactee comprises:
obtaining, using one or more sensors, sensor data associated with an interactee, in response to the execution of each of the one or more second-level actions; and
detecting the reaction of the interactee based on the sensor data.

15. The method of claim 14, wherein the sensor data comprises at least one of an animation, a movement, a tone of voice, and a facial expression of the interactee.

16. The method of claim 1, wherein the interactee is one of a human, a robot, a computing device, and a virtual character.

17. A system for performing interaction, the system comprising:
a processor;
a memory communicatively coupled to the processor, wherein the memory stores a plurality of processor-executable instructions which upon execution by the processor cause the processor to:
configure a hierarchical action-structure, in response to receiving a predefined objective, wherein configuring the hierarchical action-structure comprises:
determining one or more first-level actions associated with the predefined objective; and
determining one or more second-level actions associated with each of the one or more first-level actions;
execute each of the one or more first-level actions by executing each of the corresponding one or more second-level actions;
detect a reaction of an interactee in response to the execution of each of the one or more second-level actions;
determine a fitness value associated with each of the one or more second-level actions and each of the one or more first-level actions for fitness with the predefined objective, the fitness value being determined based the detected reaction; and
reconfigure the hierarchical action-structure, based on the determined fitness value.

18. The system of claim 17, wherein the plurality of processor-executable instructions, upon execution by the processor, further cause the processor to:
compare the fitness value associated with each of the one or more first-level actions with a predefined first fitness threshold value; and
compare the fitness value associated with each of the one or more second-level actions with a predefined second fitness threshold value.

19. The system of claim 18, wherein the reconfiguring comprises:
removing a second-level action of the one or more second-level actions, when the fitness value associated with the second-level action is less than the predefined second fitness threshold value; and
removing a first-level action of the one of the one of more first-level actions, when the fitness value associated with the first-level action is less than the predefined first threshold value.

20. The system of claim 18, wherein the reconfiguring further comprises at least one of:
generating at least one new second-level action related to a second-level action of the one or more second-level actions, when the fitness value associated with the second-level action of the one or more second-level actions is greater than the predefined second threshold value; and
generating at least one new first-level action related to a first-level action of the one or more first-level actions, when the fitness value associated with the first-level action of the one or more first-level actions is greater than the predefined first threshold value.

21. The system of claim 18, wherein the configuring comprises:
determining a first sequence associated with the one or more first-level actions associated with the predefined objective, wherein the one or more first-level actions are to be executed in the first sequence; and
determining a second sequence associated with the one or more second-level actions associated with each of the one or more first-level actions, wherein the one or more second-level actions are to be executed in the second sequence,
wherein each of the first sequence and the second sequence is predicted based on at least one of: a probability distribution model and a fuzzy logic model.

22. The system of claim 21, wherein the reconfiguring further comprises at least one of:
rearranging the one or more first-level actions associated with the first sequence, based on the comparison of the fitness value associated with each of the one or more first-level actions with the predefined first threshold value; and
rearranging the one or more second-level actions associated with the second sequence, based on the comparison of the fitness value associated with each of the one or more second-level actions with the predefined second threshold value.

23. The system of claim 17, wherein the fitness value associated with a second-level action of the one or more second-level actions is determined based on one or more criteria, wherein the one or more criteria comprises:
a perceptibility of the second-level action by the interactee;
a measurability of the reaction of the interactee in response to the execution of the second-level action; and
a relatability of the second-level action with remaining of the one or more second-level actions.

24. The system of claim 17, wherein the plurality of processor-executable instructions, upon execution by the processor, further cause the processor to:
receive a predicted reaction of the interactee associated with each of the one or more second-level actions; and
determine the fitness value associated with each of the one or more second-level actions and each of the one or more first-level actions for fitness with the predefined objective, the fitness value being determined based on a comparison of the detected reaction with the predicted reaction.

25. The system of claim 17, wherein configuring the hierarchical action-structure further comprises:
assigning an immunity status to a first-level action of the one or more first-level actions or a second-level action of the one or more second-level actions, wherein the immunity status is to make the first-level action and the second-level action immune to the reconfiguring.

26. The system of claim 1, wherein detecting the reaction of the interactee comprises:
obtaining, using one or more sensors, sensor data associated with an interactee, in response to the execution of each of the one or more second-level actions,
wherein the sensor data comprises at least one of an animation, a movement, a tone of voice, and a facial expression of the interactee; and detecting the reaction of the interactee based on the sensor data.

27. A non-transitory computer-readable medium storing computer-executable instructions for performing interaction, the computer-executable instructions configured for:
configuring a hierarchical action-structure, in response to receiving a predefined objective, wherein configuring the hierarchical action-structure comprises:
determining one or more first-level actions associated with the predefined objective; and
determining one or more second-level actions associated with each of the one or more first-level actions;
executing each of the one or more first-level actions by executing each of the corresponding one or more second-level actions;
detecting a reaction of an interactee in response to the execution of each of the one or more second-level actions;
determining a fitness value associated with each of the one or more second-level actions and each of the one or more first-level actions for fitness with the predefined objective, the fitness value being determined based the detected reaction; and
reconfiguring the hierarchical action-structure, based on the determined fitness value.

28. The non-transitory computer-readable medium of claim 27, wherein the computer-executable instructions are further configured for:
comparing the fitness value associated with each of the one or more first-level actions with a predefined first fitness threshold value; and
comparing the fitness value associated with each of the one or more second-level actions with a predefined second fitness threshold value.

29. The non-transitory computer-readable medium of claim 28, wherein the reconfiguring comprises at least one of:
removing a second-level action of the one or more second-level actions, when the fitness value associated with the second-level action is less than the predefined second fitness threshold value;
removing a first-level action of the one of the one of more first-level actions, when the fitness value associated with the first-level action is less than the predefined first threshold value;
generating at least one new second-level action related to a second-level action of the one or more second-level actions, when the fitness value associated with the second-level action of the one or more second-level actions is greater than the predefined second threshold value; and
generating at least one new first-level action related to a first-level action of the one or more first-level actions, when the fitness value associated with the first-level action of the one or more first-level actions is greater than the predefined first threshold value.

30. The non-transitory computer-readable medium of claim 28, wherein the configuring comprises:
determining a first sequence associated with the one or more first-level actions associated with the predefined objective, wherein the one or more first-level actions are to be executed in the first sequence; and
determining a second sequence associated with the one or more second-level actions associated with each of the one or more first-level actions, wherein the one or more second-level actions are to be executed in the second sequence,
wherein each of the first sequence and the second sequence is predicted based on at least one of: a probability distribution model and a fuzzy logic model.

31. The non-transitory computer-readable medium of claim 30, wherein the reconfiguring further comprises at least one of:
rearranging the one or more first-level actions associated with the first sequence, based on the comparison of the fitness value associated with each of the one or more first-level actions with the predefined first threshold value; and
rearranging the one or more second-level actions associated with the second sequence, based on the comparison of the fitness value associated with each of the one or more second-level actions with the predefined second threshold value.
